(19) United States
(12) Patent Application Publication
(10) Pub. No.: US 2002/0039459 A1
(43) Pub. Date: Apr. 4, 2002

(54) Ceramic ball, ball bearing, motor having bearing, hard disk drive, polygon scanner, and method for manufacturing ceramic ball

(75) Inventors: Tomonori Niwa, Aichi (JP); Tetsuji Yogo, Aichi (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: NGK SPARK PLUG CO., LTD.

(21) Appl. No.: 09/908,662

(22) Filed: Jul. 20, 2001

(30) Foreign Application Priority Data
Jul. 21, 2000 (JP) 2000-221084

(51) Int. Cl. F16C 33/32

(52) U.S. Cl. 384/492; 384/907.1

(57) ABSTRACT

A ceramic ball is described wherein no magnetic inclusion is observed on a surface of said ceramic ball, or when a magnetic inclusion is observed on the surface, dmax of the observed magnetic inclusion is not greater than 20 μm, wherein dmax is the distance between parallel lines circumscribing the observed magnetic inclusion and whose distance is the greatest among such circumscribing parallel lines.

### FIELD OF THE INVENTION

The present invention relates to a ceramic ball, a method for manufacturing the ceramic ball, a ball bearing using the ceramic ball, a motor having a bearing using the ball bearing, a hard disk drive using the motor, and a polygon scanner using the motor.

### BACKGROUND OF THE INVENTION

Balls for use in a bearing (hereinafter called bearing balls) are generally made of metal, such as bearing steel. However, in view of higher wear resistance, bearing balls made of ceramic are becoming popular. Meanwhile, in many cases, conventional ceramic bearing balls for use with, for example, a spindle of an ordinary machine tool contain pores, metallic foreign matter, an aggregate of impurities, or like inclusions. However, in such applications, not much attention has been paid to such pores or inclusions, since they have been considered to have no significant effect on bearing performance.

However, since ceramic balls of a ball bearing used in a drive unit of precision electronic equipment, such as a hard disk drive of a computer or a polygon scanner, rotate at high speed, presence of even a slight defect, a small amount of metallic foreign matter, or a small aggregate of impurities on the surface of a ceramic ball causes undesirable noise and vibration. Alternatively, metallic foreign matter or an aggregate of impurities present on the surface of a ceramic ball comes off the surface, with a resultant impairment in wear resistance.

An object of the present invention is to provide a ceramic ball capable of suppressing occurrence of unusual noise and vibration even in application to a bearing rotating at high speed, a method for manufacturing the ceramic ball, a ball bearing using the ceramic ball, a motor having a bearing using the ball bearing, a hard disk drive using the motor, and a polygon scanner using the motor.

### SUMMARY OF THE INVENTION

To achieve the above object, a ceramic ball of the present invention is characterized in that no magnetic inclusion is observed on a surface of the ceramic ball, or when a magnetic inclusion is observed on the surface, dmax of the observed magnetic inclusion is not greater than 20 μm, wherein dmax is the distance between parallel lines circumscribing the observed magnetic inclusion and whose distance is the greatest among such circumscribing parallel lines.

Herein, dmax of a grain or pore is defined in the following manner. As shown in FIG. 1, dmax is the distance between parallel lines circumscribing the outline of a magnetic inclusion, an aggregate of impurities, or a pore appearing on an observed surface and whose distance is the greatest among such circumscribing parallel lines.

The above-mentioned ceramic balls can be effectively used as rolling elements of a bearing; for example, as bearing balls of a bearing used in a rotary drive unit of precision equipment, such as peripheral equipment of a computer—a hard disk drive (hereinafter called an HDD), a CD-ROM drive, an MO drive, or a DVD drive—or a polygon scanner of a laser printer. A bearing used in a rotary drive unit of such precision equipment must rotate at a high speed of, for example, not less 8000 rpm (in some cases not less than 10000 rpm or not less than 30000 rpm). Even in applications of such high-speed rotation, the ceramic ball of the present invention exhibits effective suppression of occurrence of unusual noise and vibration and exhibits excellent wear resistance, since an included particle is unlikely to come off from the surface thereof. With a recent explosive increase in production of peripheral equipment of a computer, such as laser printers and hard disk drives, there has been eager demand for technology for manufacturing small high-performance ceramic balls for bearings at high efficiency. The present invention enhances efficiency of machining, such as precision polishing, which is a determinant of the rate of manufacture of bearing balls, thereby enabling low-cost, efficient supply of high-performance bearing balls for use in a bearing of a hard disk drive or a polygon scanner.

### BRIEF DESCRIPTION OF THE DRAWINGS

FIG. 1 is a view showing the definition of the size of a particle.

FIG. 2 is a view showing a step for purify a fluid material.

FIG. 3 is a view showing the action of a magnetic separator.

FIG. 4 is a view showing the action of a sieve.

FIG. 5 is a longitudinal sectional view showing an example of apparatus for manufacturing forming material powder.

FIG. 6 shows the action of the apparatus of FIG. 5.

FIG. 7 is a view showing an action subsequent to that of FIG. 6.

FIG. 8 is a view showing a step of rolling granulation.

FIG. 9 is a view showing a step of rolling granulation subsequent to the step of FIG. 8.

FIGS. 10(a)-(d) show a rolling granulation process, depicting the progress of rolling granulation.

FIG. 11 is a view showing the concept of the diameter of a primary particle and the diameter of a secondary particle.

FIGS. 12(a) and (b) are views showing the concept of cumulative relative frequency.

FIGS. 13(a)-(e) are views showing several examples of a forming nucleus.

FIGS. 14(a)-(e) are views showing several examples of a method for manufacturing a forming nucleus.

FIGS. 15(a) and (b) are views showing several examples of a method for manufacturing a green body.

FIGS. 16 is a schematic view showing a ball bearing using ceramic balls of the present invention.

FIG. 17 is a longitudinal sectional view showing an example of a hard disk drive for computer use using the ball bearing of FIG. 16.

FIG. 18 is a sectional view showing an example of a hard disk drive for computer use equipped with a head drive mechanism.

FIG. 19 is an image (A) showing the surface of a ceramic ball falling outside the scope of the present invention as observed through a metallograph.

FIG. 20 is an image (B) showing the surface of a ceramic ball falling outside the scope of the present invention as observed through a metallograph.

FIG. 21 is an image (C) showing the surface of a ceramic ball falling outside the scope of the present invention as observed through a metallograph.

FIGS. 22(i a)-(c) are sectional views showing an example of a polygon scanner using the ball bearing of FIG. 16.

### DETAILED DESCRIPTION OF THE INVENTION

Manufacture of ceramic balls involves the possibility of magnetic substances being mixed in material in various processes. When such magnetic inclusions are present on the surface of a ceramic ball, such magnetic inclusions project from the surface, causing impairment in dimensional accuracy of the ceramic ball. Also, when the surface of the ceramic ball is polished, such magnetic inclusions come off, thereby scratching the polished surface of the ceramic ball, resulting in impairment in the accuracy of finishing of the polished surface. Thus, a magnetic inclusion present on the surface of a ceramic ball impairs the accuracy of finishing of the surface, thereby causing occurrence of undesirable noise and vibration in application to a bearing for high-speed rotation (for example, a rotational speed of not less than 8000 rpm) to be used in, for example, an HDD or a polygon scanner. Also, as a result of rotation at high speed, a magnetic inclusion present on the surface of a ceramic ball becomes likely to come off, causing impairment in wear resistance.

The inventors of the present invention carried out extensive studies and found that, in the case of a ceramic ball to be used in a ball bearing which must exhibit high accuracy and rotate at high speed, such as a ball bearing for use in an HDD or a polygon scanner, attainment of a size limited to not greater than 20 μm with respect to a magnetic inclusion observed on the surface of the ceramic ball effectively prevents occurrence of undesirable noise and vibration and suppresses impairment in wear resistance, which would otherwise result from coming off of the magnetic inclusion.

When the size of a magnetic inclusion observed on the surface of a ceramic ball is in excess of 20 μm, the above-mentioned effects cannot be sufficiently obtained. Preferably, the size of a magnetic inclusion observed on the surface is not greater than 15 μm. Ideally, no magnetic inclusion is observed on the surface.

Magnetic inclusions are unavoidably contained in a material powder for a ceramic ball, or are mixed in material during mixing, pulverization, or conveyance of the material. For example, when material is mixed in a mixer or pulverized in a pulverizer or when material is conveyed through a pipe, the mixer, pulverizer, or pipe may become a source of contamination. Also, wear particles of media used in pulverization or wear particles of a stirrer used in mixing may be mixed in material. In order to prevent such contamination, in many cases, ceramic media are used in manufacture of ceramic, and when a ferrous stirrer is to be used, the stirrer is coated with ceramic. However, little attention has been paid to a pipe through which a fluid material (for example, slurry) is conveyed, since contamination occurring during conveyance is less noticeable than that during pulverization and mixing. In the great portion of a pipe, ferrous material of the pipe is exposed to materials flowing through the interior of the pipe. A long pipe involves difficulty in treating the inner wall against wear; for example, in coating the inner wall with ceramic.

However, studies conducted by the present inventors have revealed that a pipe is most responsible for generation of magnetic inclusions. Specifically, the friction of a fluid material against the inner wall of a pipe causes generation of wear particles of pipe material. Such wear particles tend to be contained as magnetic inclusions in a ceramic product. In many cases, a pipe is made of stainless steel because of its good corrosion resistance, and particularly ferritic or austenitic stainless steel, in order to enable welding of pipe fittings. These stainless steels exhibit relatively low hardness, and thus tend to generate magnetic inclusions as a result of wear caused by friction with a fluid material containing hard ceramic particles.

In order to prevent presence of magnetic inclusions in a ceramic ball, magnetic inclusions which are mixed in material during preparation of the material must be removed from the material to the greatest possible extent. As disclosed in, for example, Japanese Patent No. 3004562 and Japanese Patent Application Laid-Open (kokai) No. 2000-1372, magnetic inclusions can be removed through attraction effected by a magnetic separator. According to the present invention, in order to prevent occurrence of unusual noise and vibration when ceramic balls are incorporated in a ball bearing for use in an HDD, the size of a magnetic inclusion present on the surface of the ceramic ball must be not greater than 20 μm; thus, the extent of removal of magnetic inclusions must be enhanced accordingly. However, the above-mentioned publications do not refer to the size of residual magnetic inclusions and thus do not disclose the intensity of magnetic field generated by the magnetic separator which is necessary for regulating the size of residual magnetic inclusions to the above-described specific value.

In view of the above-mentioned problems, the present inventors carried out extensive studies, and as a result, attained the following method for manufacturing the desired ceramic ball. Specifically, the method comprises:

a fluid material refinement step for causing a fluid material containing a material powder for ceramic to pass at least once through a magnetic separator having a magnetic attractor of a surface magnetic-flux density of not less than 8000 gauss so as to remove a magnetic inclusion from the fluid material through adsorption of the magnetic inclusion on the magnetic attractor;

a step for forming a spherical green body from the fluid material; and

a step for firing the obtained green body.

As a result of a fluid material passing through a magnetic separator having a magnetic attractor of a surface magnetic-flux density of not less than 8000 gauss, magnetic inclusions of more than 20 μm in size can be very effectively separated and removed from the fluid material. Thus, the size of a magnetic inclusion observed on the surface of a ceramic ball can be limited to not greater than 20 μm.

An important point of the method of the present invention lies in setting the surface magnetic-flux density of a magnetic attractor, with which a fluid material comes into contact, to not less than 8000 gauss. The fluid material contains magnetic inclusions of various sizes. The size of a magnetic inclusion that can be adsorbed on the magnetic attractor depends on the magnetic force; i.e., the surface magnetic-flux density, of the magnetic attractor. Specifically, when the size of a magnetic inclusion is too small, the surface area per unit volume of the magnetic inclusion becomes large; thus, a resistance force per unit volume of the magnetic inclusion imposed on the magnetic inclusion from the fluid material increases accordingly. As a result, the magnetic inclusion is unlikely to be attracted by the magnetic attractor. Since such small magnetic inclusions that hardly affect a sintered ceramic ball do not need to be removed by means of the magnetic attractor, the magnetic force of the magnetic attractor must be determined on the basis of a lower limit size of the magnetic inclusions to be removed.

According to the present invention, the lower limit size is set to 20 μm, and the surface magnetic-flux density of a magnetic attractor is set to a corresponding level; specifically, not less than 8000 gauss. Thus, the magnetic attractor can very effectively attract and remove magnetic inclusions of more than 20 μm in size, which would otherwise significantly affect the performance of a sintered ceramic ball serving as a bearing ball. As a result, the size of a magnetic inclusion observed on the surface of a sintered ceramic ball can be limited to not greater than 20 μm.

As mentioned previously, conceivably, when a fluid material is conveyed through a pipe, material particles for ceramic contained in the fluid material erode the inner wall of the pipe to thereby generate magnetic inclusions. Meanwhile, stainless steel is generally used as material for the pipe. A magnetic attractor having a surface magnetic-flux density of not less than 8000 gauss can adsorb magnetic inclusions derived from, for example, not only ferritic stainless steel, which is predominantly composed of the ferromagnetic phase, but also austenitic stainless steel (for example, SUS304), which contains a certain amount of ferrite phase. More preferably, the surface magnetic-flux density of the magnetic attractor is not less than 10000 gauss.

In order to attain the above-mentioned level of surface magnetic-flux density, an electromagnet can be used. However, a permanent-magnet-type magnetic attractor is preferred, since it does not require a coil and can efficiently apply a magnetic field to a narrow space. In order to attain the above-mentioned level of surface magnetic-flux density, a rare-earth-type permanent magnet; for example, a rare-earth-iron-boron-type sintered permanent magnet, can be favorably used. Notably, the surface magnetic-flux density of the magnetic attractor is an average value as measured in a region corresponding to the magnetic surface of an employed permanent magnet.

Preferably, in the above-mentioned ceramic ball of the present invention, no aggregate of impurities is observed on a surface of the ceramic ball, or when an aggregate of impurities is observed on the surface, dmax of the observed aggregate of impurities is not greater than 20 μm, wherein dmax is a distance between parallel lines circumscribing the observed aggregate of impurities and whose distance is the greatest among such circumscribing parallel lines.

Manufacture of ceramic balls involves the possibility that aggregates of impurities are mixed in material due to various factors relevant to individual processes. When such aggregates of impurities are present on the surface of a ceramic ball, such aggregates of impurities project from the surface, causing impairment in dimensional accuracy of the ceramic ball. Also, when the surface of the ceramic ball is polished, such aggregates of impurities come off, thereby scratching the polished surface of the ceramic ball, resulting in impairment in the accuracy of finishing of the polished surface. Thus, as mentioned previously, in application to a bearing for high-speed rotation to be used in, for example, an HDD or a polygon scanner, an aggregate of impurities present on the surface of a ceramic ball causes occurrence of unusual noise and vibration. Also, as a result of rotation at high speed, an aggregate of impurities present on the surface of a ceramic ball becomes likely to come off, causing impairment in wear resistance.

The present inventors carried out extensive studies and found that, in application of a ceramic ball to a ball bearing for high-speed rotation to be used in, for example, an HDD or a polygon scanner, through attainment of no inclusion of an aggregate of impurities or through attainment of a size limited to not greater than 20 μm with respect to an aggregate of impurities observed on the surface of the ceramic ball, occurrence of unusual noise and vibration can be effectively prevented or suppressed, and wear resistance can be enhanced.

When the size of an aggregate of impurities observed on the surface of a ceramic ball is in excess of 20 μm, the above-mentioned effects cannot be sufficiently yielded. Preferably, the size of an magnetic inclusion observed on the surface is not greater than 15 μm. Ideally, no aggregate of impurities is observed on the surface.

In order to fall within the above-mentioned range of the size of an aggregate of impurities remaining on the surface of a sintered body in manufacture of ceramic balls, aggregates of impurities must be removed from material to the greatest possible extent. Specifically, the fluid material refinement step of the method for manufacturing a ceramic ball of the present invention preferably comprises a classification step for causing the fluid material to pass at least once through a sieve having apertures of not greater than 25 μm so as to remove aggregates of impurities. Through use of a sieve having an aperture size of not greater than 25 μm, aggregates of impurities can be effectively separated and removed. When aggregates of impurities include magnetic inclusions, the magnetic inclusions can also be separated and removed concurrently. Through use of a sieve having an aperture size of not greater than 20 μm (the smallest size prescribed in JIS K0211 (1987) ), the above-mentioned effects can be enhanced.

Preferably, in the ceramic ball of the present invention, no pore is observed on a surface of the ceramic ball or, when a pore is observed on the surface, dmax of the observed pore is not greater than 10 μm, wherein dmax is a distance between parallel lines circumscribing the observed pore and whose distance is the greatest among such circumscribing parallel lines.

Conceivable causes for formation of a pore are as follows. An intergranular pore in a green body for a ceramic ball remains even after sintering; and when the aforementioned magnetic inclusion or aggregate of impurities is present in a green body, the magnetic inclusion or aggregate of impurities may drop off to thereby leave a pore after sintering. In some cases, a pore is formed around a magnetic inclusion or an aggregate of impurities observed on the cross section or surface of a ceramic ball. This occurs in the case of a metallic magnetic inclusion or an aggregate of metallic impurities. Since such a magnetic inclusion or an aggregate of impurities is greater in coefficient of thermal expansion than ceramic, the magnetic inclusion or the aggregate of impurities contracts more than does a ceramic component during cooling after sintering. Also, during firing, a magnetic inclusion or an aggregate of impurities may melt to thereby leave a pore. In application of a ceramic ball to a bearing for high-speed rotation to be used in, for example, an HDD or a polygon scanner, a pore remaining on the surface of the ceramic ball causes occurrence of undesirable noise and vibration.

However, through attainment of a size of a pore observed on the surface of a ceramic ball of not greater than 10 μm, the problems mentioned above can be effectively prevented. Preferably, the size of a pore is not greater than 5 μm. Ideally, no pore is observed on the surface.

Next, the present invention provides a ball bearing having a plurality of ceramic balls incorporated therein as rolling elements. The ball bearing can be used in, for example, a hard disk drive as a bearing member for a shaft for rotating a hard disk or as a bearing member for a rotary shaft for driving a head arm. Also, the ball bearing can be used as a bearing member for a shaft for rotating a polygon mirror of a polygon scanner to be used in, for example, a laser printer. The present invention also provides a motor having a bearing characterized in that the ball bearing mentioned above is used as a bearing member. The present invention further provides a hard disk drive comprising the above-mentioned motor having a bearing and a hard disk to be rotated by the motor, as well as a polygon scanner comprising the above-mentioned motor having a bearing and a polygon mirror to be rotated by the motor.

The ceramic ball of the present invention is characterized in that the size of a magnetic inclusion or an aggregate of impurities observed on the cross section and surface of the ceramic ball is not greater than 20 μm and that the size of a pore observed on the cross section and surface of the ceramic ball is not greater than 10 μm. Such a ceramic ball can be effectively used as a bearing ball for an HDD or a polygon scanner. A ball bearing having a plurality of the present invention bearing balls incorporated therein does not generate undesirable noise and vibration and can maintain good performance over a long period of time even when used in a hard disk drive as a bearing member for a shaft for rotating a hard disk or as a bearing member for a rotary shaft for driving a head arm, or when used as a bearing member for a shaft for rotating a polygon mirror of a polygon scanner to be used in, for example, a laser printer, and rotated at a high speed of, for example, not less than 8000 rpm.

Embodiments of the present invention will next be described.

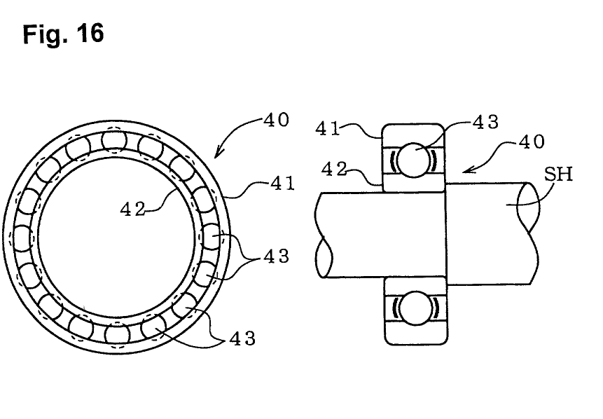

FIG. 16 shows a ball bearing 40 configured such that ceramic balls 43 according to an embodiment of the present invention are incorporated between an inner ring 42 and an outer ring 41, which are made of metal or ceramic. When a shaft SH is fixedly attached to the internal surface of the inner ring 42 of the ball bearing 40, the ceramic balls 43 are supported rotatably or slidably with respect to the outer ring 41 or the inner ring 42. As described previously, the ceramic ball 43 is characterized in that no magnetic inclusion is observed on the surface thereof or in that, when a magnetic inclusion is observed on the surface, the size of the observed magnetic inclusion is not greater than 20 μm. Preferably, the ceramic ball 43 is such that no aggregate of impurities is observed or such that, when an aggregate of impurities is observed, the size of the observed aggregate of impurities is not greater than 20 μm. Also, preferably, the ceramic ball 43 is such that no pore is observed or such that, when a pore is observed, the size of the observed pore is not greater than 10 μm.

An embodiment of the present invention will be described with reference to the case where a ceramic ball is made of silicon nitride ceramic. Preferably, a silicon nitride powder serving as material is such that the a phase makes up not less than 70% the main phase thereof. To the silicon nitride powder, at least one element selected from the group consisting of rare-earth elements and elements belonging to Groups 3A, 4A, 5A, 3B, and 4B is added as a sintering aid in an amount of 1-15% by weight, preferably 2-8% by weight, on the oxide basis. Notably, in preparation of the material, these elements may be added in the form of not only oxide but also a compound to be converted to oxide in the course of sintering, such as carbonate or hydroxide.

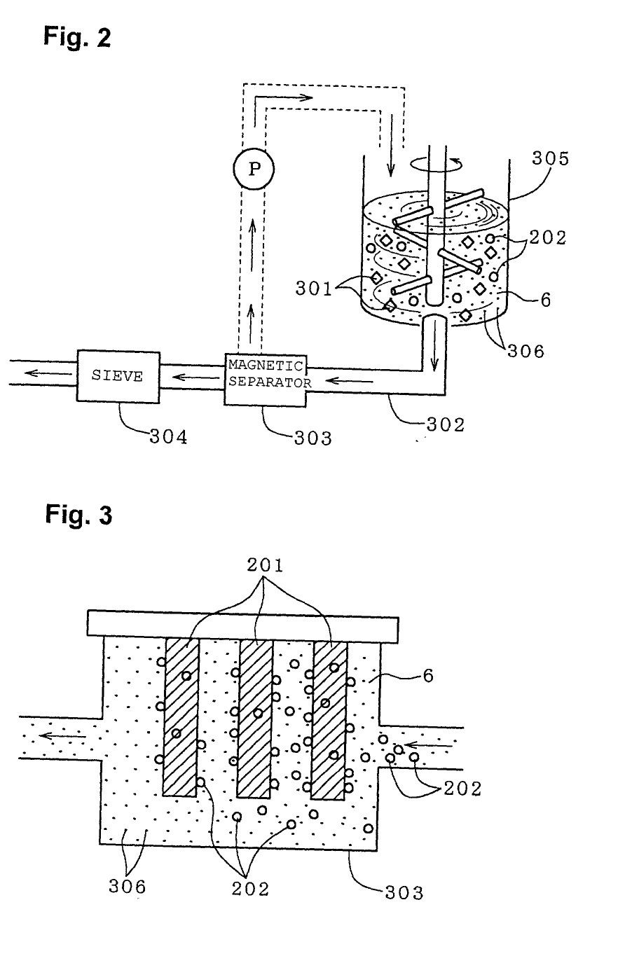

Next, FIG. 2 schematically shows a process for purify a fluid material. However, a process for generating a fluid material is not limited thereto. First, to the above-mentioned mixture, an aqueous solvent is added. The resultant mixture is wet-mixed (or wet-mixed and pulverized) by use of a pulverizer 305, such as an attriter, thereby yielding a slurry 6. The slurry 6 is sent to a magnetic separator 303 through a pipe 302. When the slurry 6 contains magnetic inclusions 202, as shown in FIG. 3, the magnetic inclusions 202 are attracted by the magnetic force of magnetic attractors 201 disposed within the magnetic separator 303, to thereby be separated from the slurry 6. The magnetic attractor 201 contains a permanent magnet; for example, a rare-earth permanent magnet, such as a rare-earth-iron-boron-type sintered permanent magnet. The magnetic attractor 201 is adapted to produce a magnetic flux density of not less than 8000 gauss on the surface thereof, preferably not less than 10000 gauss. For example, the magnetic inclusions 202 derived from wear particles of a ferrous pipe material are attracted by the magnetic attractors 201, to thereby be separated and removed from the slurry 6.

As shown in FIG. 2, the slurry 6 may be circulated to the pulverizer 305 by means of a pump P, to thereby repeat a process for separating the magnetic inclusions 202. As a result, the remaining amount of magnetic inclusions 202 can be reduced to the greatest possible extent.

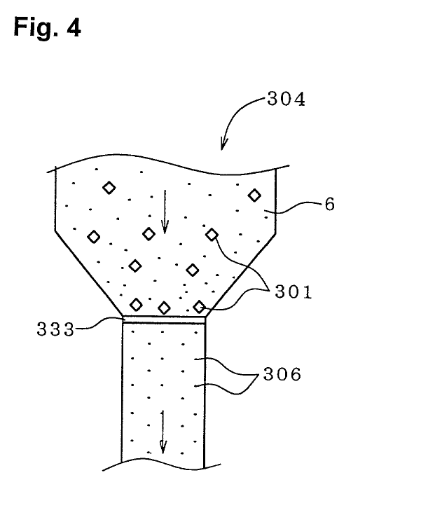

The slurry 6 from which the magnetic inclusions 202 have been removed to the greatest possible extent is sent to a sieve 304. Apertures formed in the sieve 304 each assume a size of not greater than 25 μm; for example, approximately 20 μm. For example, as shown in FIG. 4, a sieve face 333 is arranged in a slurry conveyance path in such a manner as to perpendicularly intersect with the conveyance direction. As a result, when the slurry 6 contains aggregates of impurities 301, aggregates of impurities 301 greater than sieve apertures are filtered out by means of the sieve face 333, to thereby be separated from the slurry 6. A forming material powder is prepared from the thus-refined slurry 6 as will be described below. Then, the forming material powder can be effectively formed into spherical green bodies by a rolling granulation process, which will be described later. However, the present invention is not limited to the method for preparing a forming material powder and the method for forming green bodies that are described below.

In order to be compatible with the rolling granulation process to be described later, a forming material powder preferably has an average grain size of 0.3-2 μm and a 90% grain size of 0.7-3.5 μm as measured by use of a laser diffraction granulometer and a BET specific surface area of 5-13 m²/g. These preferences are not applicable when a forming process other than the rolling granulation process is to be employed.

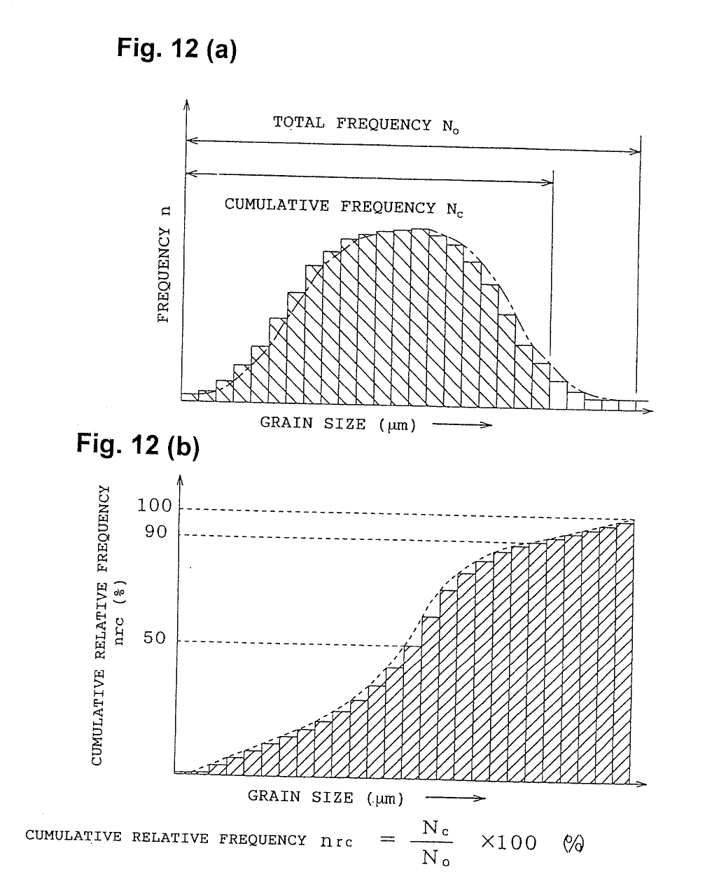

The grain size measured by means of a laser diffraction granulometer reflects the diameter of a secondary particle D shown in FIG. 11. The cumulative relative frequency with respect to grain size as measured in the ascending order of grain size is defined in the following manner. As shown in FIG. 12, frequencies of grain sizes of particles to be evaluated are distributed in the ascending order of grain size. In the cumulative frequency distribution of FIG. 12, Nc represents the cumulative frequency of grain sizes up to the grain size in question, and N0 represents the total frequency of grain sizes of particles to be evaluated. The relative frequency nrc is defined as “(Nc/N0)×100 (%).” The X% grain size refers to a grain size corresponding to nrc=X (%) in the distribution of FIG. 12. For example, the 90% grain size is a grain size corresponding to nrc=90 (%).

The specific surface area of the forming material powder is measured by the adsorption method. Specifically, the specific surface area can be obtained from the amount of gas adsorbed on the surface of powder particles. According to general practice, an adsorption curve indicative of the relationship between the pressure of gas to be measured and the amount of adsorption is obtained through measurement. The known BET (an acronym representing originators, Brunauer, Emett, and Teller) formula related to polymolecular adsorption is applied to the adsorption curve so as to obtain the amount of adsorption vm upon completion of a monomolecular layer. A BET specific surface area calculated from the obtained amount of adsorption vm is used as the specific surface area of the powder. However, when approximation does not make much difference, the amount of adsorption vm of the monomolecular layer may be read directly from the adsorption curve. For example, when the adsorption curve contains a section in which the pressure of gas is substantially proportional to the amount of adsorption, the amount of adsorption corresponding to the low-pressure end point of the section may be read as the vm value (refer to the monograph by Brunauer and Emett appearing in The Journal of American Chemical Society, Vol. 57 (1935), page 1754). Since molecules of adsorbed gas penetrate into a secondary particle to thereby cover individual constituent primary particles of the secondary particle, the specific surface area obtained by the adsorption method reflects the specific surface area of a primary particle and thus reflects the average value of the diameter of a primary particle d shown in FIG. 11.

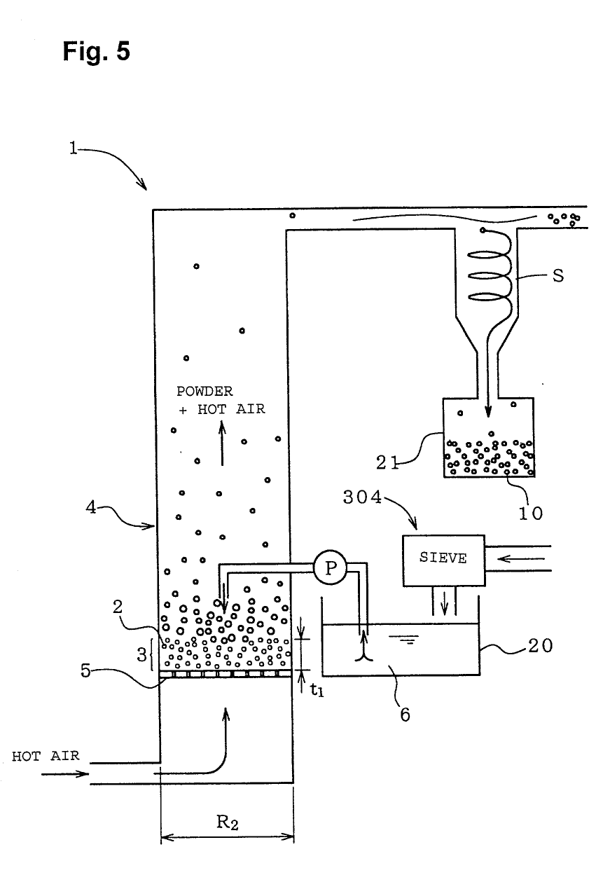

A method for preparing a forming material powder and a method for forming a green body from the forming material powder will be described. FIG. 5 shows an embodiment of an apparatus used in a process for preparing the forming material powder. In the apparatus, a hot air passage 1 includes a vertically disposed hot air duct 4. The hot air duct 4 includes a drying-media holder 5, which is located at an intermediate position of the hot air duct 4 and which includes a gas pass body, such as mesh or a plate having through-holes formed therein, adapted to permit passage of hot air and adapted not to permit passage of drying media 2. The drying media 2 are each composed of a ceramic ball, which is formed predominantly of alumina, zirconia, or a mixture thereof. The drying media 2 aggregate on the drying-media holder 5 to form a layer of drying-media aggregate 3.

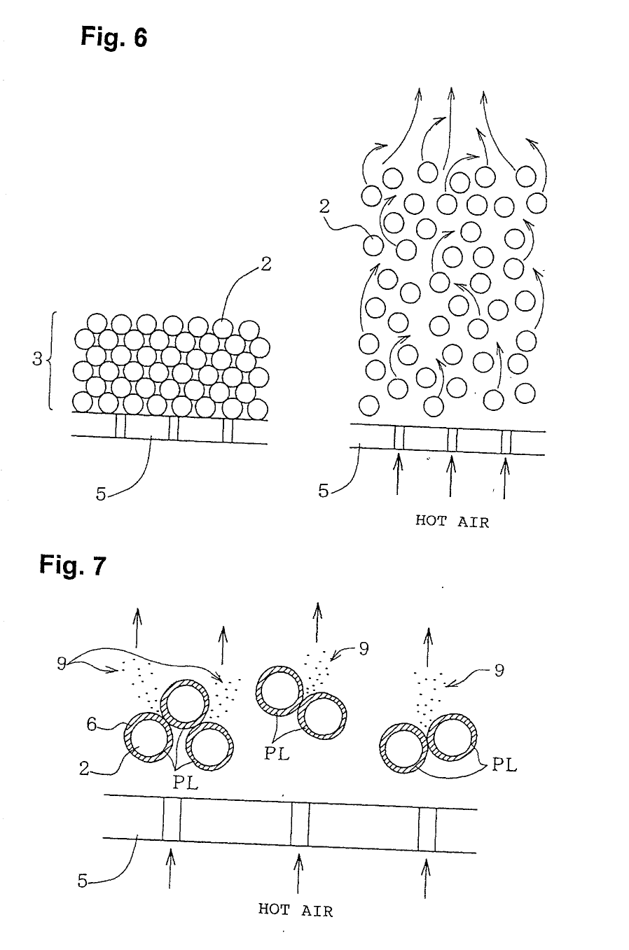

As shown in FIG. 6, hot air is caused to flow through the drying-media aggregate 3 from underneath the drying-media holder 5 and to flow upward through the hot air duct 4 while agitating the drying media 2. As shown in FIG. 5, a pump P pumps up a slurry 6 from a slurry tank 20. The slurry 6 is fed to the drying-media aggregate 3 from above and through effect of gravity. As shown in FIG. 7, the slurry 6 adheres to the surfaces of the drying media 2 while being dried by hot air, thereby forming a powder aggregate layer PL on the surface of each drying medium 2.

The flow of hot air causes repeated agitation and fall of the drying media 2. Thus, the individual pieces of drying media 2 collide and rub against one another, whereby the powder aggregate layers PL are pulverized into forming material powder particles 9. Some of the forming material powder particles 9 assume the form of a solitary primary particle, but most of the forming material powder particles 9 assume the form of a secondary particle, which is the aggregation of primary particles. The forming material powder particles 9 having a grain size not greater than a certain value are conveyed downstream by hot air (FIG. 5). The forming material powder particles 9 having a grain size greater than a certain value are not blown by hot air, but again fall onto the drying-media aggregate 3, thereby undergoing further pulverization effected by the drying media 2. The forming material powder particles 9 conveyed downstream by hot air pass through a cyclone S and are then collected as forming material powder 10 in a collector 21.

In FIG. 5, the diameter of the drying medium 2 is determined as appropriate according to the cross-sectional area of the hot air duct 4. If the diameter of the drying medium 2 is insufficient, a sufficiently large impact force will not be exerted on the powder aggregate layers PL formed on the drying media 2. As a result, the forming material powder 10 may fail to have a predetermined grain size. If the diameter of the drying medium 2 is excessively large, the flow of hot air will encounter difficulty in agitating the drying media 2, again causing poor impact force. As a result, the forming material powder 10 may fail to have a predetermined grain size. Preferably, the drying media 2 are substantially uniform in diameter so as to leave an appropriate space thereamong, whereby the motion of the drying media 2 is accelerated during flow of hot air.

A thickness t1 of the drying media 2 of the drying-media aggregate 3 is determined such that the drying media 2 move appropriately according to the velocity of hot air. If the thickness t1 is excessively large, the drying media 2 will encounter difficulty in moving, causing poor impact force. As a result, the forming material powder 10 may fail to have a predetermined grain size. If the thickness t1; i.e., the amount of the drying media 2, is excessively small, the drying media 2 will collide less frequently, resulting in impaired processing efficiency.

The temperature of hot air is determined such that the slurry 6 is dried sufficiently and the forming material powder 10 does not suffer any problem, such as thermal deterioration. For example, when a solvent used for preparation of the slurry 6 is composed predominantly of water, hot air having a temperature lower than 100° C. fails to sufficiently dry the fed slurry 6. The resultant forming material powder 10 has an excessively high water content and thus tends to agglomerate. As a result, the forming material powder 10 may fail to have a predetermined grain size. The velocity of hot air is determined so as not to cause the drying media 2 to fly into the collector 21. If the velocity is excessively low, the drying media 2 will encounter difficulty in moving, resulting in poor impact force. As a result, the forming material powder 10 may fail to have a predetermined grain size. If the velocity is excessively high, the drying media 2 will fly too high, causing reduced frequency of collision. As a result, processing efficiency will decrease.

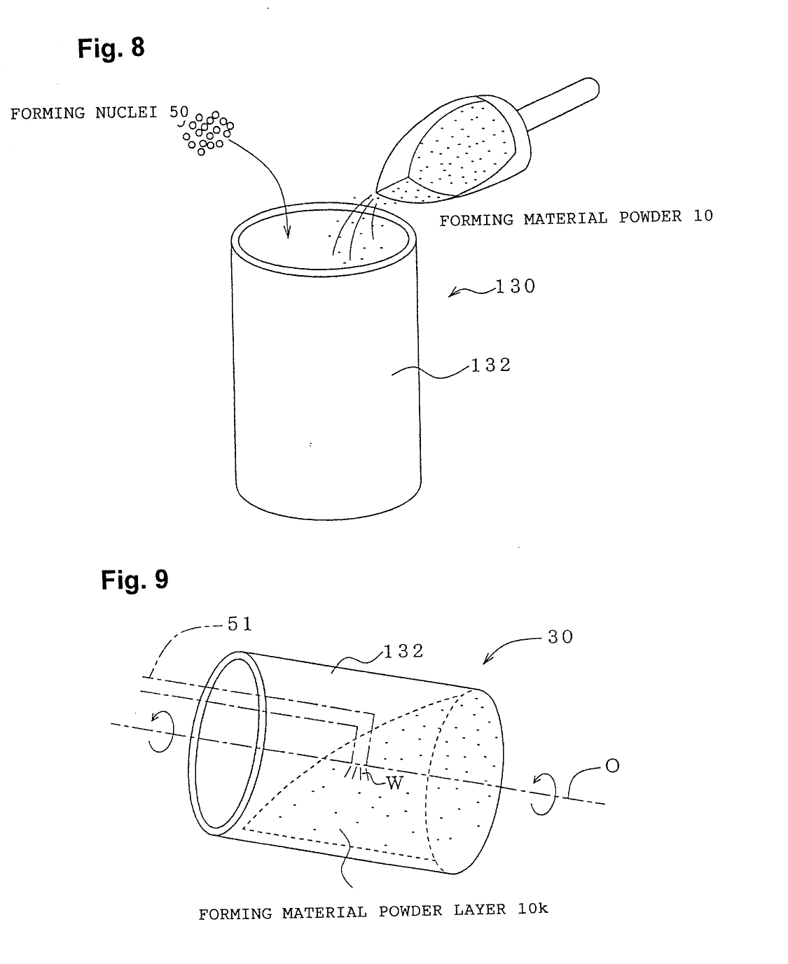

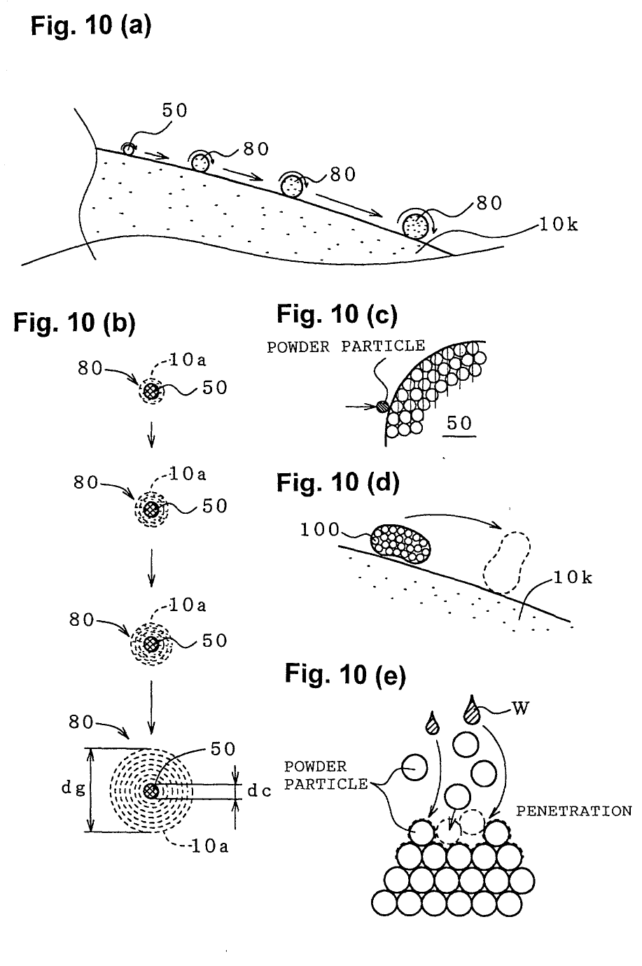

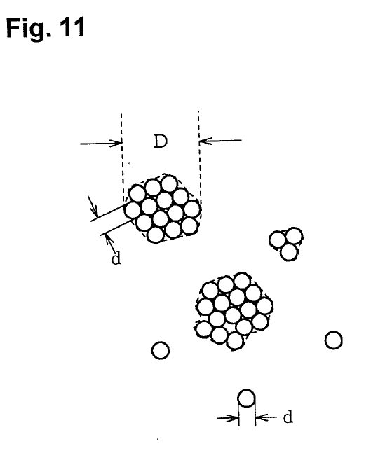

The thus-obtained forming material powder 10 can be formed into spherical bodies by means of the rolling granulation process. Specifically, as shown in FIG. 8, the forming material powder 10 is placed in a granulation container 132. As shown in FIG. 9, the granulation container 132 is rotated at a constant peripheral speed. Water W is fed to the forming material powder 10 contained in the granulation container 132, through, for example, spraying. As shown in FIG. 10, the charged forming material powder 10 rolls down an inclined powder layer 10k formed in the rotating granulation container 132 to thereby spherically aggregate into a green body 80. The operating conditions of a rolling granulation apparatus 30 are adjusted such that the obtained green body G assumes a relative density of not lower than 61%. Specifically, the rotational speed of the granulation container 132 is adjusted to 10-200 rpm. The water feed rate is adjusted such that the finally obtained green body 80 assumes a water content of 10-20% by weight. As shown in FIG. 10(e), as a result of feed of water, water penetrates into intergranular spaces to thereby further densify a green body.

Through employment of rolling granulation described above, highly dense, spherical green bodies each having a diameter of, for example, up to approximately 10 mm can be manufactured at very high efficiency. In the case of such a small-diameter green body that the ratio between surface area A′ and weight W′, A′/W′, is not less than 350 (for example, the diameter is not greater than 6.73 mm), the green body can assume a density level of approximately 2.0-2.5 g/cm³, which cannot be attained by an ordinary pressing process.

In order to accelerate the growth of the green body 80 during rolling granulation, as shown in FIG. 8, preferably, forming nuclei 50 are placed in the granulation container 132. While the forming nucleus 50 is rolling down the forming material powder layer 10k as shown in FIG. 10(a), the forming material powder 10 adheres to and aggregates on the forming nucleus 50 spherically, as shown in FIG. 10(b), to thereby form the spherical green body 80 (rolling granulation process). The green body 80 is sintered to thereby become a ceramic ball.

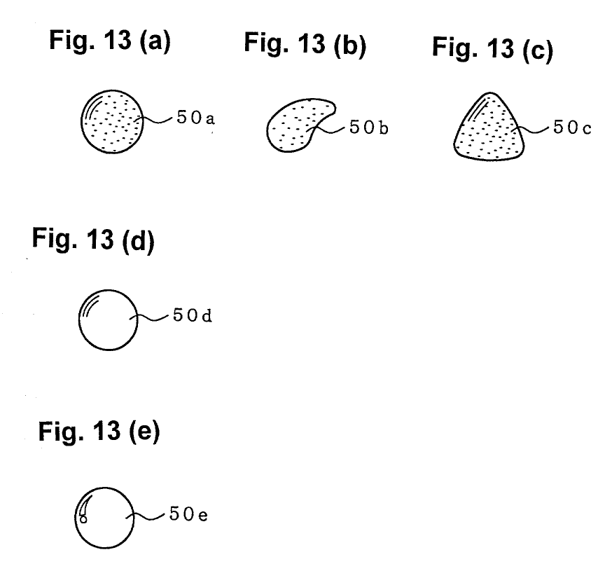

Preferably, the forming nucleus 50 is formed predominantly of ceramic powder as represented by a forming nucleus 50a shown in FIG. 13(a); for example, the forming nucleus 50 is formed of a material having composition similar to that of the forming material powder 10 (however, a ceramic powder different from the ceramic powder (inorganic material powder) constituting predominantly the forming material powder 10 may be used). This is because the nucleus 50a is unlikely to act as an impurity source on the finally obtained ceramic ball 90. However, when there is no possibility of a nucleus component diffusing to a surface layer portion of the ceramic ball 90, the nucleus 50 may be formed of a ceramic powder different from the ceramic powder (inorganic material powder) constituting predominantly the forming material powder 10; alternatively, the nucleus 50 may be a metal nucleus 50d shown in FIG. 13(d) or a glass nucleus 50e shown in FIG. 13(e). Also, the nucleus 50 may be formed of a material which disappears through thermal decomposition or evaporation during firing; for example, the nucleus 50 may be formed of a polymeric material, such as wax or resin. The forming nucleus 50 may assume a shape other than sphere, as shown in FIG. 13(b) or 13(c) Preferably, the forming nucleus 50 assumes a spherical shape, as shown in FIG. 13(a), in order to enhance the sphericity of a green body to be obtained.

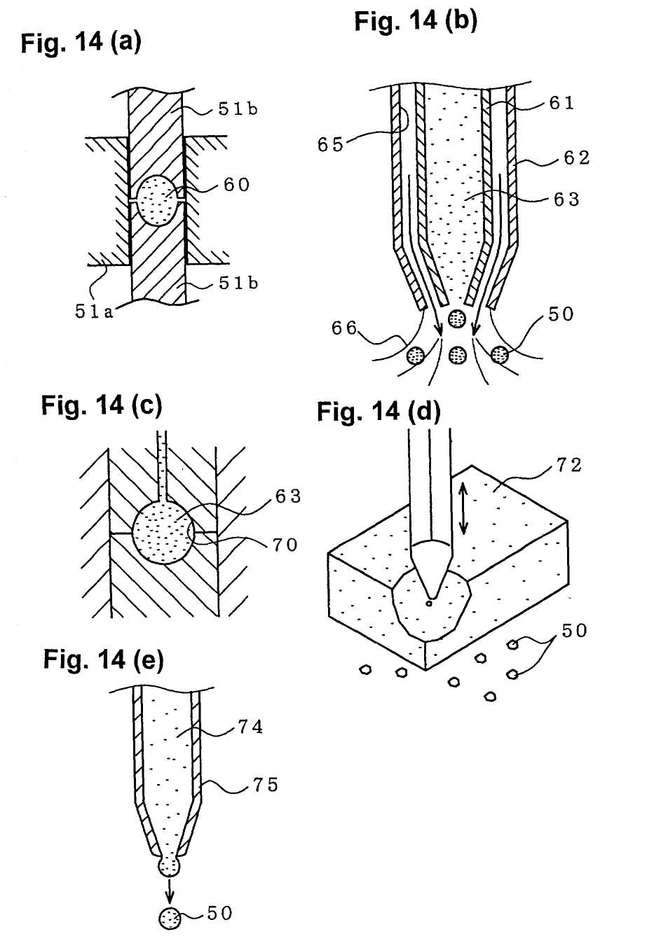

A method for manufacturing the forming nuclei 50 is not particularly limited. When the forming nuclei 50 are composed predominantly of ceramic powder, for example, various methods as shown in FIG. 14 can be employed. According to the method shown in FIG. 14(a), a ceramic powder 60 is compacted by means of a die 51a and press punches 51b (other compression means may be used instead), thereby obtaining the nucleus 50. According to the method shown in FIG. 14(b), ceramic powder is dispersed into a molten thermoplastic binder to obtain a molten compound 63, and the thus-obtained molten compound 63 is sprayed and solidified, thereby obtaining the nuclei 50. According to the method shown in FIG. 14(c), the molten compound 63 is injected into a spherical cavity formed in an injection mold, thereby molding the spherical nucleus 50. According to the method shown in FIG. 14(e), the molten compound 74 is caused to fall freely from a nozzle so as to assume a spherical shape by means of surface tension effect, and the thus-formed spherical droplet is cooled and solidified in the air to become the nucleus 50. Alternatively, slurry is formed from material powder, a monomer (or a prepolymer), and a dispersant solvent. The slurring is dispersed in a liquid which does not mix with the slurry, so as to assume the form of globules in the liquid. Then, the monomer or prepolymer is polymerized, thereby obtaining spherical bodies, which serve as the nucleus 50. Alternatively, the forming material powder 10 is singly placed in the granulation container 132, and the granulation container 132 is rotated at a speed lower than that for growing the green body 80 (see FIG. 9), so as to form powder aggregates. When powder aggregates of sufficiently large size are generated in a sufficient amount, the rotational speed of the aggregation container 132 is increased to thereby grow the green bodies 80 while utilizing the aggregates as the nuclei 50. In this case, there is no need to place the nuclei 50 manufactured in a separate process, in the granulation container 132 together with the forming material powder 10.

The thus-obtained forming nucleus 50 does not collapse and can stably maintain the shape even when some external force is imposed thereon. Thus, when the nucleus 50 rolls down the forming material powder layer 10k as shown in FIG. 10(a), the nucleus 50 can reliably sustain reaction induced from its own weight. Conceivably, since powder particles which are caught on the rolling nucleus 50 can be firmly pressed on the surface of the nucleus 50 as shown in FIG. 10(c), the powder particles are appropriately compressed to thereby grow into a highly dense aggregate layer 10a. By contrast, as shown in FIG. 10(d), when no nucleus is used, an aggregate 100 corresponding to a nucleus is formed merely on accidental basis. Also, since the aggregate 100 is rather loose and soft, during rolling down the forming material powder layer 10k, the aggregate 100 deforms, or, in the worst case, collapses, failing in many cases to induce adhesion and aggregation of powder particles. As a result, formation of a green body consumes much time, and a formed green body becomes highly likely to contain a defect, such as cracking and a pore formed as a result of bridging of powder particles.

The size of the nucleus 50 is at least approximately 40 μm (preferably, approximately 80 μm). When the nucleus 50 is too small, the growth of the aggregate layer 10a may become incomplete. When the nucleus 50 is too large, the thickness of the aggregate layer 10a to be formed becomes insufficient; as a result, a sintered body tends to suffer occurrence of defect. Preferably, the size of the nucleus 50 is, for example, not greater than 1 mm.

Preferably, the forming nucleus 50 assumes the form of an aggregate of ceramic powder having a density higher than the bulk density (for example, apparent density prescribed in JIS Z2504 (1979)) of the forming material powder 10. Such an aggregate of ceramic powder can reliably sustain the pressing force of powder particles to thereby accelerate the growth of the aggregate layer 10a. Specifically, an aggregate of ceramic powder having a density at least 1.5 times the bulk density of the forming material powder 10 is preferred. In this case, sufficient aggregation is such that, when an aggregate rolls down the forming material powder layer 10k, the aggregate does not collapse from the shock of rolling.

In order to grow the green body 80 more stably, preferably, the size of the nucleus 50 is determined according to the size of the green body 80 in the following manner. As shown in FIG. 10(b), the size of the forming nucleus 50 is represented by the diameter dc of a sphere having a volume equal to that of the nucleus 50 (when the nucleus 50 is spherical, the diameter thereof is the size in question), and the diameter of the finally obtained spherical green body 80 is represented by dg. The diameter dc is determined such that dc/dg is 1/100-½. When dc/dg is less than 1/100, the nucleus 50 becomes too small, potentially causing insufficient growth of the aggregate layer 10a or occurrence of many defects in the aggregate layer 10a. When dc/dg is in excess of ½, and the density of the nucleus 50 is not sufficiently high, the strength of a sintered body to be obtained may become insufficient. The ratio dc/dg is preferably 1/50-⅕, more preferably 1/20-1/10. The size dc of the forming nucleus 50 is preferably 20-200 times the average grain size of the forming material powder 10. Preferably, the absolute value of the size dc is, for example, 50-500 μm.

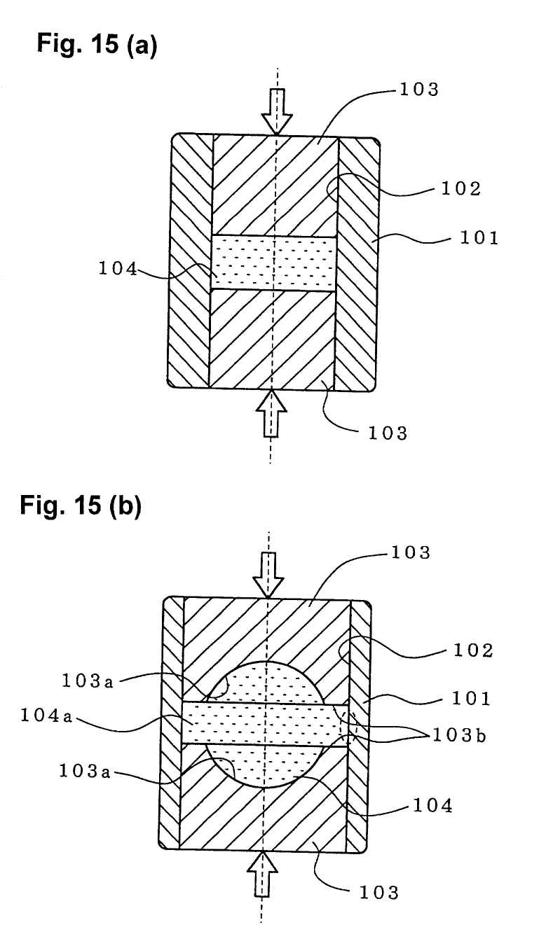

FIG. 15(b) shows a forming process other than the rolling granulation process. Upper and lower press punches 103 are inserted into a die hole 102 formed in a forming die 101. A hemispheric cavity 103a is formed on the end face of each of the upper and lower press punches 103. Powder is compressed between the upper and lower press punches 103, thereby yielding a spherical ceramic green body 104. Preferably, the punches 103 used in such a die pressing process are such that peripheral edge portions of the punching faces of the press punches 103 are flattened so as to increase the pressing pressure in these regions. However, this process involves formation of a flange-like unnecessary portion 104a, corresponding to the flattened portions 103b, on the green body 104. This unnecessary portion 104a must be removed through polishing before or after sintering. Alternatively, as shown in FIG. 15(a), a green pellet may be formed.

In manufacture of ceramic balls, in place of die pressing, cold isostatic pressing (CIP) may be employed. Specifically, a spherical preliminary green body is formed by, for example, the die pressing process described above. The preliminary green body is placed in a rubber tube in a sealed condition. Then, pressure is isostatically applied to the thus-prepared preliminary green body through application of hydrostatic pressure by means of medium for spherical formation, such as oil or water. When the density of a green body is not sufficiently enhanced after a single practice of cold isostatic pressing, cold isostatic pressing may be repeatedly carried out; i.e., a cyclic CIP process may be employed.

The following method other than the die pressing process can also be employed. A forming material powder is dispersed in a thermoplastic binder to thereby form a slurry. This slurry is subjected to free fall from a nozzle. While assuming the form of a sphere by the action of surface tension, each droplet of the slurry is cooled and solidified in the air (as disclosed in, for example, Japanese Patent Application Laid-Open (kokai) No. 63-229137). Alternatively, a forming material powder, a monomer (or prepolymer), and a dispersion solvent are mixed so as to obtain a slurry. This slurry is dispersed in the form of droplets in a liquid which does not blend with the slurry. In this dispersed state, the monomer or prepolymer is polymerized, thereby obtaining spherical green bodies (as disclosed in, for example, Japanese Patent Application Laid-Open (kokai) No. 8-52712).

A spherical green body obtained by any of the above-described methods is fired in the following manner to thereby become the ceramic ball of the present invention. Firing can be performed, for example, in two stages; i.e., primary firing and secondary firing. Primary firing is performed at a temperature not higher than 1900° C. in nonoxidizing atmosphere containing nitrogen and having a pressure of 1-10 atm. such that a sintered body obtained through primary firing has a density of not less than 78%, preferably not less than 90%. When a sintered body obtained through primary firing has a density of less than 78%, the sintered body which has undergone secondary firing tends to suffer occurrence of a number of remaining defects, such as remaining pores. Secondary firing can be performed at a temperature of 1600-1950° C. in nonoxidizing atmosphere containing nitrogen and having a pressure of 10-1000 atm (the concept of hot isostatic pressing is included). When the pressure of secondary firing is lower than 10 atm., decomposition of silicon nitride cannot be suppressed. Even when the pressure of secondary firing is increased in excess of 1000 atm., no advantage is gained with respect to effect, but rather disadvantage results with respect to cost. When the temperature of secondary firing is lower than 1600° C., a defect, such as a pore, cannot be eliminated with a resultant impairment in strength. Notably, when, under firing conditions corresponding to the above-mentioned conditions of secondary firing, sufficient densification can be attained with reduced occurrence of defect, primary firing can be omitted; i.e., a single-stage firing can be employed. Secondary firing can be performed in an atmosphere containing nitrogen and having the atmospheric pressure or a pressure of not higher than 200 atm., to thereby suppress excessive increase in surface hardness of an obtained sintered body (unfinished bearing ball). As a result, machining, such as polishing, can be performed smoothly, to thereby readily attain required dimensional accuracy of a polished bearing ball, such as required sphericity and diametral irregularity.

As shown in FIG. 16, ceramic balls 43 obtained as above are incorporated between an inner ring 42 and an outer ring 41, which are made of, for example, metal or ceramic, thereby yielding a radial ball bearing 40. When a shaft SH is fixedly attached to the internal surface of the inner ring 42 of the ball bearing 40, the ceramic balls 43 are supported rotatably or slidably with respect to the outer ring 41 or the inner ring 42.

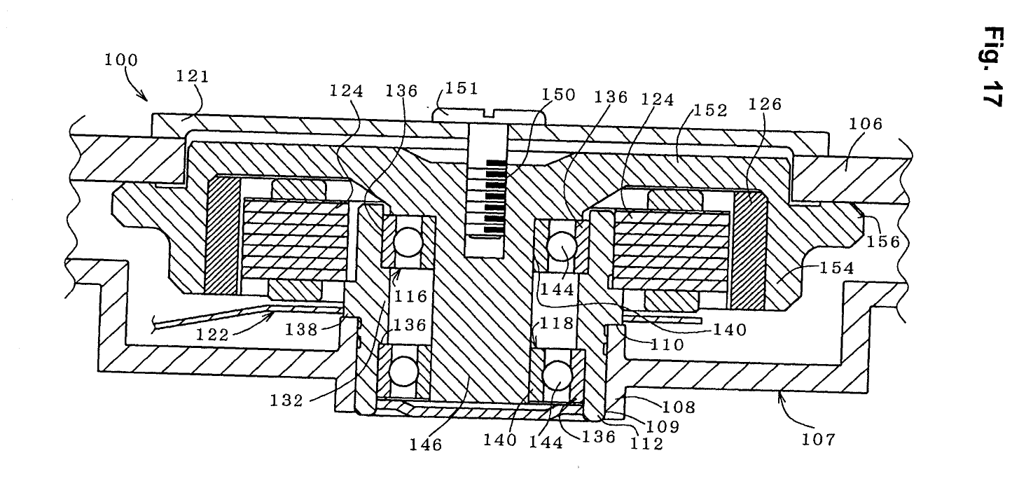

FIG. 17 is a longitudinal sectional view showing an example of configuration of a hard disk drive using the above-mentioned ball bearing. The hard disk drive 100 includes a body casing 107; a cylindrical shaft holder portion 108 formed at the center of the bottom of the body casing 107 in a vertically standing condition; and a cylindrical bearing holder bush 112 coaxially fitted to the shaft holder portion 108. The bearing holder bush 112 has bush fixation flanges 110 and 138 formed on the outer circumferential surface thereof and is axially positioned while the bush fixation flanges 110 and 138 abuts one end of the shaft holder portion 108. Ball bearings 116 and 118 configured in the same manner as shown in FIG. 16 are coaxially fitted into the bearing holder bush 112 at the corresponding opposite end portions of the bush 112 while abutting the corresponding opposite ends of a bearing fixation flange 132 projecting inward from the inner wall of the bearing holder bush 112 to thereby be positioned. The ball bearings 116 and 118 are configured such that a plurality of ceramic balls 144 of the present invention are disposed between an inner ring 140 and an outer ring 136.

A disk-rotating shaft 146 is fixedly fitted into the inner rings 140 of the ball bearings 116 and 118 to thereby be supported by the ball bearings 116 and 118 in a rotatable condition with respect to the bearing holder bush 112 and the body casing 107. A flat, cylindrical disk fixation member (rotational member) 152 is integrally formed at one end of the disk-rotating shaft 146. A wall portion 154 is formed along the outer circumferential edge of the disk fixation member in a downward extending condition. An exciter permanent-magnet 126 is attached to the inner circumferential surface of the wall portion 154. A coil 124 fixedly attached to the outer circumferential surface of the bearing holder bush 112 is disposed within the exciter permanent-magnet 126 in such a manner as to face the exciter permanent-magnet 126. The coil 124 and the exciter permanent-magnet 126 constitute a DC motor 122 for rotating the disk. The motor 122 and the bearings 116 and 118 constitute a motor having a bearing of the present invention while the disk-rotating shaft 146 serves as an output shaft. The maximal rotational speed of the motor 122 is not lower than 8000 rpm. When a higher access speed is required, the maximal rotational speed reaches 10000 rpm or higher, and, in a certain case, 30000 rpm or higher. The number of turns of the coil 124, the intensity of external magnetic field generated by the exciter permanent-magnet 126, a rated drive voltage, and a like design factor are determined appropriately in consideration of load for rotating the disk, so as to implement the above-mentioned maximal rotational speed. A disk fixation flange 156 projects outward from the outer circumferential surface of the wall portion 154 of the disk fixation member 152. An inner circumferential edge portion of a recording hard disk 106 is fixedly held between the disk fixation flange 156 and a presser plate 121. A clamp bolt 151 is screwed into the disk-rotating shaft 146 while extending through the presser plate 121.

When the coil 124 is energized, the motor 122 starts rotating to thereby generate a rotational drive force while the disk fixation member 152 serves as a rotor. As a result, the hard disk 106 fixedly held by the disk fixation member 152 is rotated about the axis of the disk-rotating shaft 146 supported by the bearings 116 and 118.

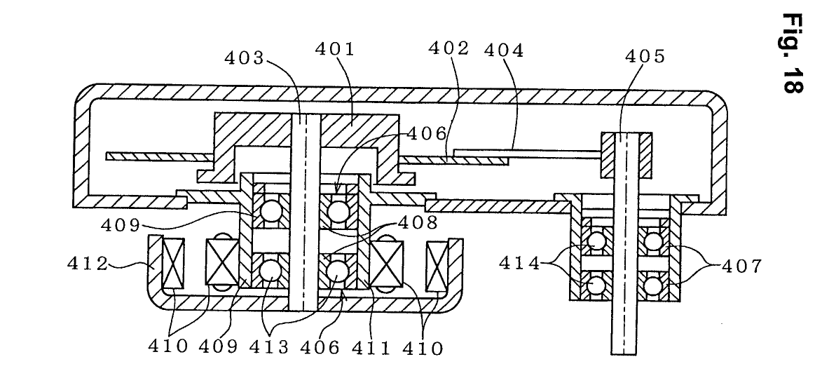

FIG. 18 shows the structure of a hard disk drive (hereinafter abbreviated to HDD) including a head arm drive unit. The structure has two rotational shafts; i.e., a rotational shaft 403 for rotationally supporting a magnetic disk 402 via a hub 401 and a rotational shaft 405 for a head arm 404 having a magnetic head (not shown) attached to its end. The rotational shaft 403 is supported by two ball bearings 406 of the present invention disposed axially apart from each other by a certain distance, whereas the rotational shaft 405 is supported by two ball bearings 407 of the present invention disposed axially apart from each other by a certain distance. The ball bearings 406 and 407 assume the same structure as that described previously. Inner rings 408 of the paired ball bearings 406 are fixedly attached to the rotational shaft 403 so as to rotate unitarily with the rotational shaft 403. Outer rings 409 of the paired ball bearings 406 are fixedly fitted into a cylindrical stator 411 of a spindle motor 410 (the spindle motor 410 and the bearings 406 constitute a motor having a bearing of the present invention, while the rotational shaft 403 serves as an output shaft of the motor). The rotational shaft 403 is located at the center of a dish-type rotor 412 and is rotated by means of the spindle motor 410.

The magnetic disk 402, which is rotatably supported as described above, rotates at high speed according to the rotational speed of the spindle motor 410. During rotation of the magnetic disk 402, the head arm 404, to which a magnetic head for reading/writing magnetic recording data is attached, operates as appropriate. The base end of the head arm 404 is supported by an upper portion of the rotational shaft 405. The rotational shaft 405 is rotated about its axis by means of an unillustrated actuator including a VCM such that the distal end of the head arm 404 is rotated by a required angle to thereby move the magnetic head to a required position. Thus, through rotational movement of the rotational shaft 405, required magnetic recording data can be read from or written to an effective recording region of the magnetic disk 402.

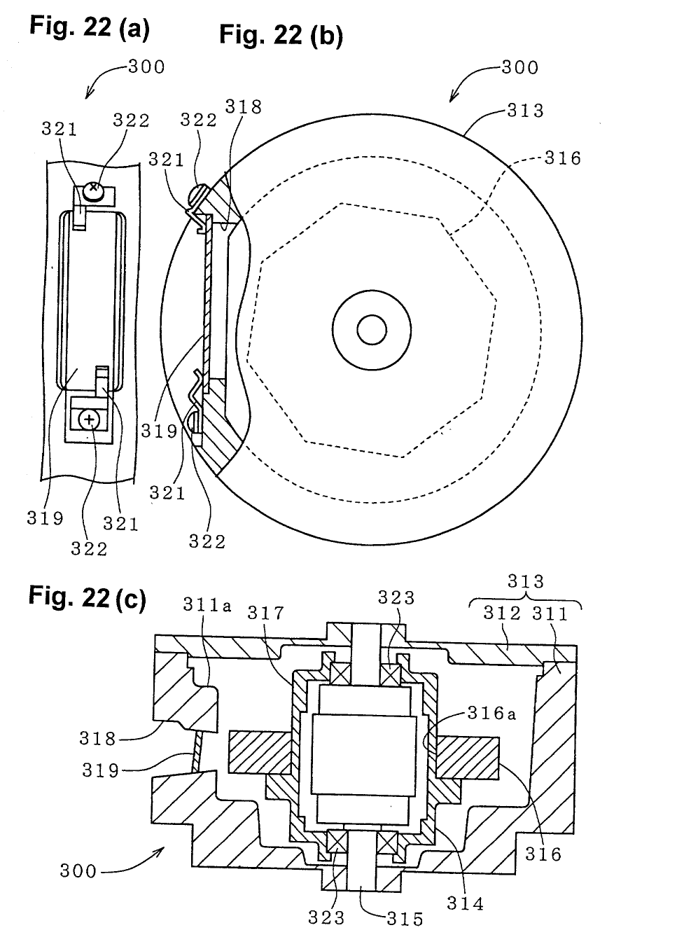

FIG. 22 shows an embodiment of a polygon scanner using the above-described ball bearing (FIG. 22(a) is a front view, FIG. 22(b) is a plan view, and FIG. 22(c) is a longitudinal sectional view). A polygon scanner 300 is used to generate a scanning light beam in image processing, such as photographing and copying, as well as in a laser printer. A motor 314 (herein, an outer rotor type), which is the motor having a bearing of the present invention, is accommodated within a substantially cylindrical enclosed case 313 composed of a body 311 and a cover 312 for covering the body 311. Opposite ends of a stationary shaft 315 are fixedly attached to the body 311 and the cover 312, respectively. A polygon mirror 316 includes a polygonal platelike member and reflectors formed on corresponding side walls of the polygonal platelike member. In the present embodiment, the polygon mirror 316 assumes the shape of a regular octagon. A rotor 317 of the motor 314 is fixedly inserted into a mounting hole 316a formed at a central portion of the polygon mirror 316, whereby the rotor 317 and the polygon mirror 316 can rotate unitarily. The rotor 317 is rotatably supported by the stationary shaft 315 via two ball bearings 323 of the present invention. The ball bearings 323 assume a structure similar to that shown in FIG. 16. The motor 314 rotates at high speed; for example, at a maximal rotational speed of not lower than 10000 rpm or 30000 rpm.

A window 318 for allowing an incoming/outgoing light beam to pass through is formed on the side wall of the body 311 in opposition to the polygon mirror 316. A window glass 319 is attached to the window 318. The window glass 319 is fitted to the window 318 from outside and is then pressed in place by means of a pair of flat springs 321. In FIG. 22, reference numeral 322 denotes a mounting screw for fixing the other end of the flat spring 321 on the body 311. A protrusion 311a is formed on the inner wall of the body 311 so as to provide a seat for the window glass 319.

When the motor 314 is operated, the polygon mirror 316 rotates about the axis of the stationary shaft 315. A light beam, such as a laser beam, entering through the window 318 impinges on the rotating polygon mirror 316 along a predetermined direction. Reflectors on the side walls of the rotating polygon mirror 316 sequentially reflect the incident light beam. The thus-reflected light beams are emitted through the window 318 and serve as scanning light beams.

Ceramic to be used is not limited to silicon nitride ceramic. For example, zirconia ceramic, alumina ceramic, or silicon carbide ceramic can be used. A process for manufacturing ceramic balls from these ceramics can be basically similar to the process for manufacturing silicon nitride ceramic balls.

Through employment of the composition of so-called partially stabilized zirconia, zirconia (zirconium oxide) ceramic can enhance toughness thereof through alleviation of transformation stress. ZrO₂ and HfO₂, which are predominant components of the zirconia ceramic phase, are known to undergo phase transformation, induced by change in temperature, among three different crystal structure phases. Specifically, these compounds assume the monoclinic system phase at low temperature, including room temperature; the tetragonal system phase at higher temperature; and the cubic system phase at further higher temperature. When the entire zirconia ceramic phase consists of at least one of ZrO₂ and HfO₂, substantially the entirety of the phase is considered to assume the monoclinic system phase at about room temperature. However, when an alkaline earth metal oxide or a rare earth metal oxide (e.g., calcia (CaO) or yttria (Y₂O₃)) serving as a stabilizing component is added in a specific amount or more to ZrO₂ and HfO₂ so as to form solid solution, the temperature of transformation between the monoclinic system phase and the tetragonal system phase is lowered, to thereby stabilize the tetragonal system phase at about room temperature.

The aforementioned phase transformation from the tetragonal system phase to the monoclinic system phase is known to be induced by the Martensitic transformation mechanism or a similar phase transformation mechanism. When external stress acts on the aforementioned tetragonal system phase, the transformation temperature increases, with the result that the tetragonal system phase undergoes stress-induced transformation. In addition, strain energy generated by the stress is consumed to induce the transformation, so that the applied stress is relaxed. Accordingly, even when stress concentrates at the end of a crack in material, through transformation from the tetragonal system phase to the monoclinic system phase, the stress is relaxed, so that propagation of cracking is stopped or mitigated. Thus, fracture toughness is enhanced.

Regarding components for stabilizing the zirconia ceramic phase, one or more species of Ca, Y, Ce, and Mg are preferably incorporated into the zirconia ceramic phase in a total amount of 1.4-4 mol % as reduced to oxides; i.e., CaO, Y₂O₃, CeO₂, and MgO, respectively. When the total amount of the components is less than 1.4 mol %, the monoclinic system phase content increases, to thereby lower the relative tetragonal system phase content. In this case, the aforementioned effect for relaxing stresses cannot be fully attained, and wear resistance of the ceramic ball might be insufficient. When the total amount of the components is in excess of 4 mol %, the cubic system phase content increases, and, similar to the above case, the wear resistance might be insufficient. Thus, the total amount of the components is preferably 1.5-4 mol %, more preferably 2-4 mol %.

Specifically, in the present invention, Y₂O₃ is preferably used as the component for stabilizing the tetragonal system phase, since Y₂O₃ is comparatively inexpensive, and a ceramic material produced by use thereof can be endowed with high mechanical strength as compared with the case in which a ceramic material is produced by use of other stabilizing components. When CaO or MgO is used, a ceramic material produced by use thereof can be endowed with comparatively high mechanical strength, which, however, is lower than that attained by use of Y₂O₃. In addition, CaO and MgO are more inexpensive than Y₂O₃. Thus, CaO and MgO are also preferably used in the present invention. Y₂O₃, CaO, and MgO may be used singly or in combination of two or more species.

ZrO₂ and HfO₂—predominant components of the zirconia ceramic phase (herein, a “predominant component” means a component of the highest content by weight)—are similar to each other in terms of chemical and physical properties. Thus, these two components may be used singly or in combination. However, more preferably, the zirconia ceramic phase is formed predominantly of ZrO₂, which is inexpensive as compared within HfO₂. In many cases, generally available ZrO₂ raw material of standard purity contains a trace amount of HfO₂. However, for the aforementioned reason, intentional removal of HfO₂ before use of such a raw material is unnecessary.

In the zirconia ceramic phase, the ratio of the weight of the cubic system phase (CW) to that of the tetragonal system phase (TW); i.e., CW/TW is preferably less than 1. The cubic system phase is prone to be generated when the temperature of transformation between the cubic system phase and the tetragonal system phase is lowered due to an increase in amount of the aforementioned stabilizing component or when the firing temperature is in excess of 1600° C. As compared with the monoclinic system phase and the tetragonal system phase, the cubic system phase tends to generate coarsening crystal grains during firing. The thus-coarsened crystal grains in the cubic system phase easily drop off, because interfacial bonding strength to other crystal grains is low. Furthermore, if the amount of the cubic system phase increases to such a level that the aforementioned ratio exceeds 1, the amount of such coarsened crystal grains increases accordingly. In either case, chipping resistance in formation of a sharp edge under the aforementioned conditions is impaired. Accordingly, the ratio CW/TW is controlled to less than 1, preferably less than 0.5, more preferably less than 0.1.

The information in relation to the ratio of the tetragonal system phase to the cubic system phase is obtained in the following manner. For example, a portion of the constituent ceramic of a ball is mirror-polished, and the thus-polished surface is investigated through X-ray diffractometry. In this case, the main diffraction peaks; i.e., that attributed to (1 1 1), of the tetragonal system phase and that of the cubic system phase, are observed in the obtained diffraction pattern such that the two peaks are close to each other. Therefore, initially, the amount of the monoclinic system phase is obtained from the ratio of the total intensity of (1 1 1) intensity and (1 1 −1) intensity (Im) to the sum of (1 1 1) intensity of the tetragonal system phase and that of the cubic system phase (It+Ic). Subsequently, the sintered ceramic material is mechanically crushed, and the crushed matter is again subjected to X-ray diffractometry, to thereby obtain (1 1 1) intensity I′m of the monoclinic system phase and (1 1 1) intensity I′c of the cubic system phase. Due to mechanical stress generated during the above crushing process, the tetragonal system phase of the sintered ceramic material is considered to be transformed to the monoclinic system phase. Thus, the amount of the cubic system phase can be obtained from the ratio, I′c/(I′m+I′c). The thus-obtained ratio I′c/(I′m+I′c) is 0.5 or less, preferably 0.1 or less, in view of enhancement of chipping resistance in formation of a sharp edge under the aforementioned conditions.

When alumina ceramic is to be used, a forming material powder for ceramic matrix can be prepared through addition of an appropriate sintering aid powder (e.g., an oxide of Mg, Ca, Si, or Na) to an alumina powder. Preferably, the thus-obtained ceramic matrix contains the above-mentioned sintering aid component in an amount of 0.1-10% by weight on the oxide basis and an Al component which constitutes the balance on the Al₂O₃ basis.

### EXAMPLE

In order to examine the effects of the present invention, the following experiment was carried out. A silicon nitride powder (average grain size: 1.0 μm; BET specific surface area: 10 m²/g) was prepared as a material powder. An alumina powder (average grain size: 0.4 μm; BET specific surface area: 10 m²/g) and an yttria powder (average grain size: 1.5 μm; BET specific surface area: 10 m²/g) were prepared as sintering aid components. The average grain size was measured by use of a laser diffraction granulometer (model LA-500, product of Horiba, Ltd.). The BET specific surface area was measured by use of a BET-specific-area measuring device (MULTISORB 12, product of Yuasa Ionics, Corp.).

The above-mentioned material powders were mixed according to the following composition: silicon nitride powder 100 parts by weight; alumina powder 3 parts by weight; and yttria powder 3 parts by weight. To the powder mixture (100 parts by weight), pure water (100 parts by weight) serving as solvent and an organic binder (an appropriate amount) were added. The resulting mixture was mixed for 10 hours by means of an attriter mill, thereby obtaining the slurry of forming material powder. The slurry of forming material powder was circulated through a pipe in which the magnetic separator 303 shown in FIG. 3 and the sieve 304 shown in FIG. 4 are installed. The magnetic separator 303 has an internal volume of 4700 cm³ and includes seven magnetic attractors. The magnetic attractors each measure 25 mm (diameter)×120 mm (length) and employ an Nd—Fe—B sintered magnet to thereby produce a magnetic flux density of 11000 gauss as measured on the outer surface thereof. The magnetic attractors are arranged perpendicularly to the slurry feed direction. The slurry was fed to the magnetic separator 303 and the sieve 304 at a rate of 10 liters/min.

The thus-refined slurry was formed into a forming material powder by use of the apparatus shown in FIG. 5. The obtained forming material powder exhibited an average grain size of 0.7 μm, a 90% grain size of 1.5 μm, and a BET specific area of 11 m²/g.

The forming material powder was subjected to rolling granulation, thereby yielding spherical green bodies. The obtained spherical green bodies underwent primary firing for 3 hours at a temperature of 1400-1750° C. in a nitrogen atmosphere at the atmospheric pressure and then underwent secondary firing for 2 hours at a temperature of 1600-1750° C. in a nitrogen atmosphere at a pressure of 50-100 atm. The resulting sintered bodies were polished to ceramic balls by use of a wet precision polishing machine and a grooved surface-plate grindstone (abrasive No.: #20000).

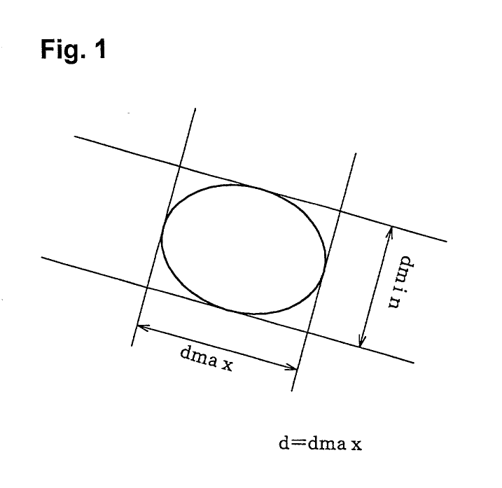

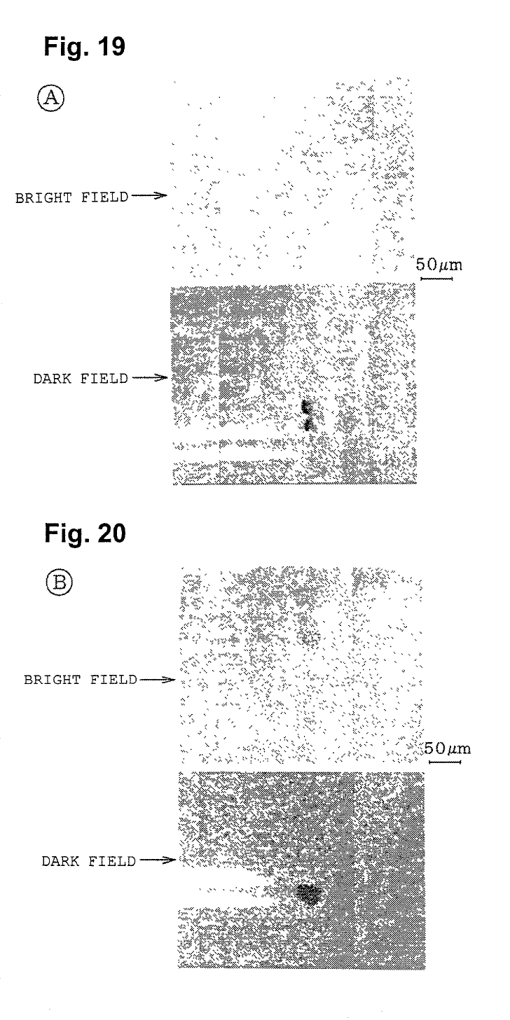

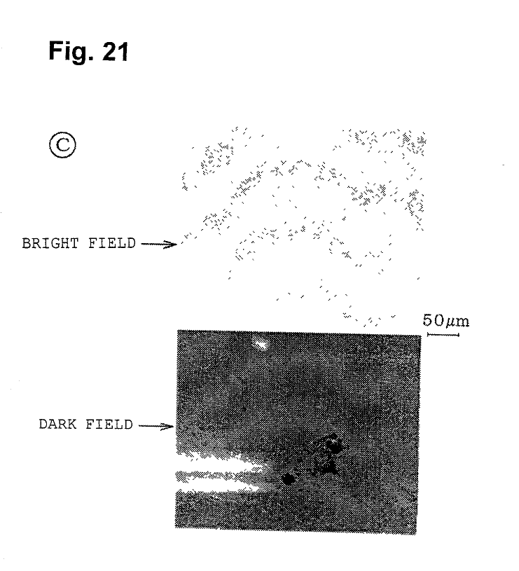

For comparison, ceramic balls were manufactured under conditions falling outside the scope of the present invention. The surfaces of the obtained ceramic balls were observed in the bright and dark fields by use of a metallograph (at 200 magnifications). The thus-obtained observation images are shown in FIG. 19 (Sample No. 4 in Table 1), FIG. 20 (Sample No. 3 in Table 1), and FIG. 21 (Sample No. 5 in Table 1). Magnetic inclusions and aggregates of impurities observed on the observation images were measured for size according to the method of FIG. 1.

Ceramic ball bearings as shown in FIG. 16 were each manufactured through incorporation of the above-mentioned ceramic balls between an outer ring of metal and an inner ring of metal. A microphone (a pickup sensor) was attached to the outer ring. While the outer ring was fixed, the inner ring was rotated at 10000 rpm to check to see whether unusual noise is generated. Evaluation was made according to the following criteria: in excess of 30 dB in sensor output: unusual noise present (X); 30-25 dB: minor unusual noise present (Δ); and less than 25 dB: normal (◯). Also, the bearings were continuously rotated at 10000 rpm for 2000 hours for life test. Evaluation was made according to the following criteria: a variation in rotational vibration is not less than 10% and/or the appearance of a ceramic ball exhibits anomaly after test: not acceptable (X); a variation in rotational vibration falls within the 10-5% range and/or the appearance of a ceramic ball exhibits no anomaly except very minor one after test: acceptable (Δ); and a variation in rotational vibration is less than 5% and the appearance of a ceramic ball exhibits no anomaly after test: good (◯) The test results are shown in Table 1.

TABLE 1

| | Manufacturing conditions | | Characteristics | | | | | |
|---|---|---|---|---|---|---|---|---|
| | Magnetic flux | | | Size of | | | | |
| | density of | Sieve | Size of | aggregate | | | | |
| Sample | magnetic separator | aperture | magnetic | impurities | Size of | Acoustic | Quality | Micro- |
| No. | [gauss] | [μm] | inclusion [μm] | [μm] | defect [μm] | eval. | eval. | graph |
| 1 | 11000 | 20 | 0 | 5 | 2 | ◯ | ◯ | — |
| 2 | 8000 | 25 | 15 | 0 | 2 | ◯ | ◯ | — |
| 3* | 5000 | 32 | 20 | 30 | 3 | Δ | X | B |
| 4* | 5000 | — | 40 | 10 | 15 | X | X | A |
| 5* | — | — | 55 | 75 | 10 | X | X | C |

Samples marked with * fall outside the scope of the invention.

The test results shown in Table 1 reveal the following. Even when used as a bearing ball in, for example, an HDD or a polygon scanner, and rotated at high speed, a ceramic ball characterized in that a magnetic inclusion or an aggregate of impurities observed on the surface or cross section thereof has a size of not greater than 20 μm and that a defect observed on the surface or cross section has a size of not greater than 10 μm can be effectively used without generation of unusual noise and can maintain quality over a long period of time.

While the present invention has been described above with reference to specific embodiments, the present invention is not limited thereto.

This application is based on Japanese Patent Application No. 2000-221084 filed Jul. 21, 2000, the disclosure of which is incorporated herein by reference in its entirety.

What is claimed is:

1. A ceramic ball wherein no magnetic inclusion is observed on a surface of said ceramic ball, or when a magnetic inclusion is observed on the surface, dmax of the observed magnetic inclusion is not greater than 20 μm, wherein dmax is the distance between parallel lines circumscribing the observed magnetic inclusion and whose distance is the greatest among such circumscribing parallel lines.

2. A ceramic ball according to claim 1, wherein no aggregate of impurities is observed on a surface of said ceramic ball, or when an aggregate of impurities is observed on the surface, dmax of the observed aggregate of impurities is not greater than 20 μm, wherein dmax is the distance between parallel lines circumscribing the observed aggregate of impurities and whose distance is the greatest among such circumscribing parallel lines.

3. A ceramic ball according to claim 1, wherein no pore is observed on a surface of said ceramic ball, or when a pore is observed on the surface, dmax of the observed pore is not greater than 10 μm, wherein dmax is the distance between parallel lines circumscribing the observed pore and whose distance is the greatest among such circumscribing parallel lines.

4. A ball bearing comprising a plurality of ceramic balls as in claim 1, 2 or 3 are incorporated therein as rolling elements.

5. A ball bearing as in claim 4, said ball bearing being used in a hard disk drive as a bearing member for a shaft for rotating a hard disk or as a bearing member for a rotary shaft for driving a head arm.

6. A motor having a bearing comprising a ball bearing as in claim 4 is used as a bearing member.

7. A motor having a bearing as in claim 6, said motor being used in a drive unit of a hard disk drive for rotating a hard disk.

8. A motor having a bearing as in claim 6, said motor being used in a drive unit of a polygon scanner for driving a polygon mirror.

9. A motor having a bearing as in claim 7, wherein said motor rotates at a maximal speed of not less than 8000 rpm.

10. A hard disk drive comprising a motor having a bearing as in claim 7 and a hard disk to be rotated by said motor.

11. A polygon scanner comprising a motor having a bearing as in claim 8 and a polygon mirror to be rotated by said motor.

12. A method for manufacturing a ceramic ball comprising:
a fluid material refinement step for causing a fluid material containing a material powder for ceramic to pass at least once through a magnetic separator having a magnetic attractor of a surface magnetic-flux density of not less than 8000 gauss so as to remove magnetic inclusions from the fluid material through adsorption of the magnetic inclusions on the magnetic attractor;
a step for forming a spherical green body from the fluid material; and
a step for firing the obtained green body.

13. A method for manufacturing a ceramic ball as in claim 12, wherein the magnetic attractor is a permanent-magnet-type magnetic attractor into which a rare-earth-type permanent magnet is incorporated.

14. A method for manufacturing a ceramic ball as in claim 12 or 13, wherein said fluid material refinement step comprises a classification step for causing the fluid material to pass at least once through a sieve having apertures of not greater than 25 μm.

15. A motor having a bearing as in claim 8, wherein said motor rotates at a maximal speed of not less than 8000 rpm.

16. A polygon scanner comprising a motor having a bearing as in claim 9 and a polygon mirror to be rotated by said motor.

17. A method for manufacturing a ceramic ball as in claim 12 wherein the magnetic attractor has a surface magnetic-flux density of not less than 10000 gauss.

18. A ceramic ball as in claim 3, wherein the dmax of an observed pore is not greater than 5 μm.
